(19) United States
(12) Patent Application Publication
(10) Pub. No.: US 2026/0213993 A1
(43) Pub. Date: Jul. 23, 2026

(54) NETWORK FUNCTION AVAILABILITY ENGINE(S) FOR ENSURING SATISFACTION OF NETWORK FUNCTION SET FAULT TOLERANCES

(71) Applicant: Oracle International Corporation, Redwood City, CA (US)

(72) Inventor: Rajiv Krishan, Cary, NC (US)

(21) Appl. No.: 19/034,273

(22) Filed: Jan. 22, 2025

(51) Int. Cl. H04L 41/0681; H04L 43/0817; H04L 45/00; H04L 67/51

(52) U.S. Cl. CPC H04L 41/0681; H04L 43/0817; H04L 45/22; H04L 67/51

(57) ABSTRACT

Various embodiments of the present technology generally relate to systems and methods for providing a network function (NF) availability engine. In an example, a first NF availability executing on a first NF instance registers a minimum availability threshold for a first NF set associated with the first NF instance with a Network Repository Function (NRF), where the minimum availability threshold defines a minimum number of NF instances required to maintain a fault tolerance level of the first NF set. The NRF then receives a discovery request containing discovery parameters associated with a first session from a consumer NF. An NF availability engine executing on the NRF determines whether the minimum availability threshold for the first NF set is satisfied and if so, generates a listing of discoverable NF profiles including a first NF profile associated with the first NF instance based on the minimum availability threshold being satisfied.

### TECHNICAL FIELD

Various embodiments of the present technology generally relate to network function communication within networks. More specifically, embodiments of the present technology relate to systems and methods for providing a network function (NF) availability engine for ensuring satisfaction of NF set fault tolerances for a minimum number of available NF instances within a given NF set.

### BACKGROUND

Communication networks, such as 4G and 5G, have become the backbone of modern communication, revolutionizing how people and devices connect across the globe. These technologies provide the essential infrastructure for high-speed, reliable wireless communication, enabling everything from everyday smartphone use to complex industrial applications. 4G networks laid the foundation by introducing fast data transfer rates and improved mobile internet experiences. Now, with the advent of 5G, the world is witnessing unprecedented advancements in speed, capacity, and low-latency communication, paving the way for transformative applications like autonomous vehicles, smart cities, and the Internet of Things (IoT). These networks collectively form the cornerstone of modern communication, driving innovation and shaping the future of global connectivity.

In view of the growing reliance on 4G and 5G networks, maintaining session resiliency has become paramount. Often, session resiliency is provided by distributing sessions across multiple instances within one or more NF sets, ensuring that even if one instance or NF set encounters issues, the network can sustain operations without interruption. To further support session resiliency, vendors and/or operators often assign fault tolerances to NF sets. That is, NF sets are engineered to operate with a defined minimum number of available instances necessary for effective service routing. As such, the NF sets can endure the failure of several NF instances up to a specified minimum availability threshold, allowing continued operation and session handling. However, if the number of available or active instances drops below an NF set's minimum availability threshold, the NF set can no longer sustain service, prompting failover processes to redirect traffic to other available NF sets. This layered approach to redundancy and fault tolerance reinforces network stability, ensuring the high availability and performance required by modern 5G applications.

Despite these advancements, current conventional approaches to network architecture and operations, particularly in 5G networks, lack mechanisms that allow consumer NFs to determine whether an NF set is operating above its minimum availability threshold during service routing. As a result, consumer NFs continue to route traffic to NF sets without visibility into their real-time health or operational state, potentially exacerbating service disruptions if the NF set is already compromised or below the minimum availability threshold.

Accordingly, there exists a need for systems and techniques for improved operational frameworks within communication networks. In particular, there is a need for an NF availability engine that determines whether an NF set is operating above its respective minimum availability threshold during service routing and provides this information to consumer NFs for NF selection.

The information provided in this section is presented as background information and serves only to assist in any understanding of the present disclosure. No determination has been made and no assertion is made as to whether any of the above might be applicable as prior art with regard to the present disclosure.

### Overview

Technology is disclosed herein for systems and techniques for providing an NF availability engine and one or more of its related functions. As described in greater detail below, the NF availability engine determines NF profiles registered with a Network Repository Function (NRF). From the registered NF profiles, the NF availability engine identifies a group of NF sets based on NF set identifiers present in the registered NF profiles. Once the NF sets are identified, the NF availability engine then determines a minimum availability threshold defined for each NF set. As described in greater detail below, the minimum availability threshold may be provided in a respective NF profile via vendor-specific extensions. In some cases, the NF availability engine generates a mapping between an NF set and its minimum availability threshold for monitoring purposes.

Once the minimum availability threshold for each NF set is determined, the NF availability engine performs a count to determine a number of available NF instances in each NF set. Using the count, the NF availability engine then determines whether a respective NF set has a satisfied minimum availability threshold. As described in greater detail below, this can include iteratively comparing the number of available instances to the minimum availability threshold on a per NF set basis. If a respective NF set has a satisfied minimum availability threshold, the NF availability engine then identifies the registered NF profiles associated with that NF set and adds those NF profiles to a listing of discoverable NF profiles. The listing of discoverable NF profiles is then used by the NF availability engine to identify NF profiles for incoming discovery requests.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a 5G network in which one or more features of an NF availability engine can be implemented, according to an embodiment herein;

FIG. 2 illustrates an example environment including three NF sets having varied minimum availability thresholds, according to an embodiment herein;

FIG. 3 illustrates an operational environment 300 including an NF availability engine, according to an embodiment herein;

FIG. 4 provides an example NF availability engine process, according to an embodiment herein;

FIG. 5 provides an example process for providing one or more functions of an NF availability engine, according to an embodiment herein;

FIG. 6 provides an example process for generating a discover response, according to an embodiment herein;

FIG. 7 illustrates an example operational flow illustrating one or more functions of a consumer-side NF availability engine, according to an embodiment herein;

FIG. 8 illustrates an example operational flow for providing an NF availability engine, according to an embodiment herein;

FIG. 9 illustrates an example operational flow for providing one or more functions of a consumer NF-side availability engine, according to an embodiment herein; and

FIG. 10 shows an example computing device suitable for providing an NF availability engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the modern era, networks, especially 5G, have become essential to both professional and personal life, transforming the way people live and work. The ultra-fast speeds, low latency, and increased capacity of 5G networks enable seamless communication, enhanced productivity, and new opportunities across various industries, including healthcare, entertainment, and manufacturing. For businesses, 5G supports remote collaboration, real-time data sharing, and advanced automation, while in daily life, it powers everything from video calls and online gaming to smart home devices and wearable technologies. As individuals and organizations increasingly rely on connectivity for nearly every aspect of life, 5G is positioned to play a crucial role in shaping the future, connecting people, communities, and industries in unprecedented ways.

Given this heavy reliance on seamless, always-on connectivity, 5G networks often depend on Network Function (NF) sets containing multiple NF instances to ensure high availability, scalability, and reliability. NF sets are used to distribute the workload and manage traffic efficiently across several instances of the same network function, allowing the network to handle increased demand without compromising performance. By deploying multiple instances, operators can balance the load, ensuring that no single instance becomes a bottleneck, and also provide redundancy in case of failures. This redundancy is crucial for maintaining uninterrupted service, especially in mission-critical applications. Additionally, using NF sets enables seamless scaling of network resources, allowing operators to dynamically adjust to changing traffic patterns or service requirements. Ultimately, NF sets improve the overall resilience and flexibility of 5G networks, ensuring that they can meet the demands of a growing number of users and devices while maintaining optimal performance.

To further enhance the reliability and performance of 5G networks, vendors and operators also implement fault tolerance mechanisms for NF sets. These fault tolerances are critical for ensuring consistent service delivery and minimizing the risk of service degradation or failure. In 5G networks, NF sets are typically deployed using an “N”+“K” model, where “N” represents the minimum number of instances required for service routing, and “K” denotes the fault tolerance level of the set. This model allows NF sets to remain operational even if up to “K” instances fail. As such, the minimum availability threshold is defined as the least number of NF instances necessary to maintain the fault tolerance level. For example, a vendor might deploy an NF set with 4 instances and a fault tolerance of 2, meaning the set can continue to function if any two instances become unavailable. Another vendor may deploy a set with 3 instances and a fault tolerance of 2, allowing the set to remain operational as long as at least one instance stays active. This flexible approach supports varying redundancy levels and enhances network resilience by enabling tailored fault tolerance configurations that meet specific operational requirements and vendor strategies.

One shortcoming of conventional network frameworks and architectures, however, is the lack of visibility regarding whether a particular NF set is meeting its minimal availability threshold, as defined by its fault tolerance. This is particularly problematic for consumer NFs, such as a Service Communication Proxy (SCP), which are often unable to determine whether the selection of a specific NF profile is part of an NF set that has met its minimum availability requirement. Without this visibility, there is no clear indication of whether the NF set is operating with the necessary redundancy or if it is at risk of service degradation due to insufficient instances being available. This lack of insight into the operational status of NF sets can lead to undetected vulnerabilities, impacting the overall reliability and performance of the network.

For example, consider a scenario where an NF set consists of 3 instances, but one instance is down for maintenance, and a second instance has failed or is not reachable by the consumer NF due to an issue. In this situation, the consumer NF must decide whether to select the third instance of that set for new sessions or whether to select instances from other sets of the same NF type. Under conventional frameworks, however, the consumer NF does not have the information required to make an informed decision, and typically will prefer the third instance in the already selected NF set. Depending on the fault tolerance of the NF set, however, selection of the third instance by the consumer NF may mean that the NF set is operating below its minimum availability threshold.

When an NF set operates below its minimum availability threshold, the overall network performance and reliability may be severely compromised. This can lead to service disruptions, increased latency, and potential outages that degrade the quality of user experiences and jeopardize mission-critical applications. For example, if the consumer NF selects the third instance of an NF set whose instance availability is below the minimum availability threshold, the network may attempt to reroute traffic to a healthier NF to ensure ongoing service delivery. This rerouting may introduce additional latency as traffic is directed to instances that are geographically distant or under higher load. In some cases, the rerouted instances may already be approaching their capacity limits, increasing the risk of oversubscription and further degrading performance. Additionally, the rerouting process itself can create signaling overhead, leading to inefficiencies in handling large volumes of simultaneous requests. If no suitable alternate instances are available, the network may experience partial service degradation, impacting non-essential functions first but potentially escalating to critical service disruptions. Over time, repeated rerouting can strain the network's resources, contributing to instability and heightening the risk of cascading failures. This ongoing fragility can undermine the network's ability to meet SLAs, resulting in customer dissatisfaction, reputational harm, and increased operational costs.

While conventional frameworks rely on load information of available instances within an NF set to determine whether a particular NF set is healthy and able to support service routing, relying solely on load information fails to provide the whole picture on the operational status of the NF set. NF instances may undergo controlled shutdowns for maintenance or become temporarily unavailable due to transient network issues, leading to misleadingly low load readings when these instances return to service. This can create the false impression that the NF set is underutilized, even if it was previously operating near or below its minimum availability threshold. Additionally, NF instances may encounter issues in accurately computing or reporting their load, further distorting the reliability of this data. As a result, selecting instances based purely on load can inadvertently lead to overburdening the remaining active instances during alternate routing, particularly when failed instances are removed from service. This increases the risk of service degradation and compromises the overall resilience of the network.

To address at least these issues, an example NF availability engine and its related functions are provided herein. As will be described in greater detail below, the NF availability engine identifies NF sets and determines respective minimum availability thresholds for each NF set. The NF availability engine then monitors whether an NF set satisfies its minimum availability threshold by performing a count of available instances within the NF set in real-time. If the NF availability engine determines that a NF set does not currently have enough available instances to satisfy its predefined minimum availability threshold, the NF availability engine may remove NF profiles associated with the NF set from a listing of discoverable NFs. By removing the NF profiles corresponding to the NF set having an unsatisfied minimum availability threshold from the listing of discoverable NF profiles, the NF availability engine ensures the instances within that NF set are not included in discovery responses, and thereby are not selected by a consumer NF for service routing.

In contrast, if the NF availability engine determines that an NF set has a satisfied minimum availability threshold, the NF availability engine adds the respective NF profiles for the NF set to the listing of discoverable NF profiles. By generating the listing of discoverable NF profiles based on NF sets that have a satisfied minimum availability threshold, the NF availability engine ensures that downstream consumer NFs only select NF profiles associated with NF sets operating above their fault tolerance.

The NF availability engine enhances overall network stability, performance and resilience, by prioritizing NF sets operating above their minimum availability threshold are selected for service routing. By prioritizing NF sets with satisfied minimum availability thresholds, the NF availability engine aids the network in maintaining consistent service delivery even during periods of high demand or unexpected failures. This proactive approach minimizes the likelihood of service disruptions, reduces latency, and preserves the quality of experience for end-users. Routing traffic exclusively to NF sets that have a satisfied minimum availability threshold helps prevent oversubscription and balances the load across healthy instances, extending the operational lifespan of network resources. Additionally, the NF availability engine reduces signaling overhead by eliminating the need for frequent rerouting, resulting in more efficient resource utilization and faster response times. Furthermore, the NF availability engine strengthens the network's ability to meet SLAs by decreasing the risk of cascading failures and ensuring redundancy is preserved. As a result, operators benefit from improved reliability, higher customer satisfaction, and reduced operational costs, fostering trust and reinforcing the network's reputation for delivering seamless, high-quality services.

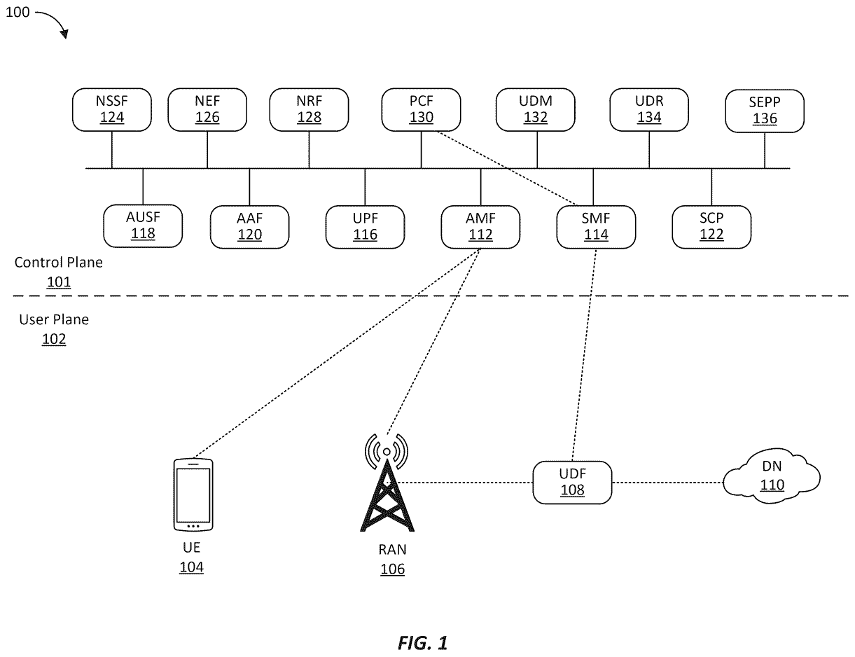

Turning now to the Figures, FIG. 1 illustrates an example operational environment for a 5G network 100 in which one or more features of an NF availability engine can be implemented, according to an embodiment herein. The example 5G network 100 is a 5G core (5GC) cellular network implementing 3GPP (3rd Generation Partnership Project) communication standards, although the present disclosure may apply to other communication networks. It should be appreciated that while the following discussion focuses on a 5G network, the NF availability engine may also operate within other communication networks. For example, the NF availability engine may be employed within a 4G network that is enabled to use 5G resources.

The 5G network 100, its components, and their sub-components may be implemented via computers, servers, hardware and software modules, or other system components. The components of the 5G network 100 and its subcomponents, or the physical devices implementing them, may be co-located, remotely distributed, or any combination thereof. The elements of 5G network 100 may include components hosted or situated in the cloud and implemented as software modules potentially distributed across one or more server devices or other physical components.

The 5G network 100 is divided into two fundamental planes: a control plane 101 and a user plane 102, each serving distinct yet interdependent roles. The control plane 101 is responsible for managing the signaling and control information necessary to establish, modify, and terminate communication sessions. The control plane 101 handles tasks such as authentication, policy enforcement, and mobility management. As such, the control plane 101 is crucial for orchestrating and controlling the NFs, ensuring efficient and secure connectivity. On the other hand, the user plane 102 deals with the actual data transmission the movement of user data between devices and applications. It is optimized for high-throughput, low-latency data delivery, and is designed to efficiently transport user traffic. The separation of the control plane 101 and user plane 102 in the 5G network 100 enhances scalability, flexibility, and enables network slicing, allowing tailored configurations to meet diverse service requirements. Together, these planes 101 and 102 form a cohesive architecture that empowers the 5G network 100 to deliver unprecedented speed, reliability, and versatility for a wide array of applications and services.

As noted above, the user plane 102 of the 5G network 100 operates in tandem with the control plane 101 to deliver efficient and seamless data transmission. For example, as illustrated, when a User Equipment (UE) 104, which could be a smartphone or any other device, initiates a communication the user plane 102 handles the actual user data traffic. When the UE 104 initiates communication, the Radio Access Network (RAN) 106 comes into play, managing the wireless connection between the UE 104 and the network 100, in particular the UE 104 and the Access and Mobility Management Function (AMF) 112. The RAN 106 acts as the bridge between the user plane 102 and the control plane 101, facilitating the establishment of communication sessions. As data travels through the RAN 106, it encounters the User Data Function (UDF) 108, which plays a pivotal role in processing and optimizing user data. The UDF 108 is responsible for tasks such as traffic optimization, content caching, and data transformation, enhancing the efficiency of data delivery.

The UDF 108 provides the data to the Data Network (DN) 110, which could represent the broader internet or a specific network service. The DN 110 processes and delivers the user data to its intended destination, completing the journey initiated by the UE 104. The collaborative operation of the user plane 102, UE 104, RAN 106, UDF 108, and DN 110 ensures that data is transmitted reliably and efficiently, meeting the high-performance expectations of 5G networks. As those skilled in the art readily appreciate, the separation of user plane 102 and control plane 101 allows for flexible network configurations and optimizations, contributing to the enhanced capabilities of the 5G ecosystem.

As noted above, when the UE 104 initiates a communication within the 5G network 100, the AMF 112 coordinates the interaction. For example, when the UE 104 initiates communication or moves within the 5G network 100, it sends signaling messages to the AMF 112. The AMF 112 is responsible for tasks such as authentication, authorization, and mobility management. Upon receiving the signaling messages from the UE 104, the AMF 112 validates the user's identity, checks for necessary permissions, and establishes the necessary context for the session. The AMF 112 coordinates with other network functions, such as the Session Management Function (SMF) 114 and the User Plane Function (UPF) 116, to ensure the seamless setup and management of communication sessions. The interaction with the control plane 101 enables the UE 104 to access network services, adhere to established policies, and maintain continuous connectivity while benefiting from the advanced capabilities and optimizations offered by the 5G network architecture.

The control plane 101 includes example components, nodes, or NFs. As illustrated, the control plane 101 includes the AMF 112, the SMF 114, the UPF 116, an Authentication Server Function (AUSF) 118, an Authentication and Authorization Function (AAF) 120, Service Communications Proxy (SCP) 122, a Network Slice Selection Function (NSSF) 124, Network Exposure Function (NEF) 126, a Network Repository Function or NF Repository Function (NRF) 128, a Policy Control Function (PCF) 130, a Unified Data Management (UDM) 132, Unified Data Repository (UDR) 134, and a Security Edge Protection Proxy (SEPP) 136. The selection of NFs 112-136 depicted in the 5G network 100 is exemplary, and some of the NFs 112-136 may be excluded, or other NFs added to the collection, without departing from the scope of this disclosure. The various NFs 112-136 execute various operations to provide communication services to UEs, such as the UE 104, that connects to the 5G network 100. A network node or NF that provides service is referred to herein as a producer NF, while a network node or NF that consumes services is referred herein to as a consumer NF. A network function can be both a producer NF and a consumer NF depending on whether it is consuming or providing service.

The NFs 112-136 of the 5G network 100 exchange various communications in the course of providing network services. The communications may include messaging to establish or end secured communication channels, such as transport layer security (TLS) handshakes, as well as service-based interface (SBI) communications. As used herein, SBI is the term given to the application programming interface (API) based communication that can take place between two NFs within the 5G SBA. A given NF can utilize an API call over the SBI to invoke a particular service or service operation. Communications between NFs 112-136 may be performed over network links and communication channels of the 5G network 100 that are not explicitly depicted in FIG. 1.

When the UE 104 initiates communication within the 5G network 100, various network functions often operate in pairs, where one NF acts as the producer (“the producer NF”), generating or providing specific services or information, and the other NF acts as the consumer (the “consumer NF”), utilizing or consuming the produced services or information to complete service requests. For instance, consider the interaction between the SMF 114 and the PCF 130. The SMF 114, as the consumer NF, initiates service requests related to session establishment, modification, or termination for UE sessions, such as for the UE 104. The SMF 114 communicates these requests to the PCF 130, acting as the producer NF, which performs functions related to session management, Quality of Service (QoS) enforcement, and access control. The PCF 130 processes the requests from the SMF 114, enforces QoS policies, manages session establishment and modification, and ensures appropriate access control based on network policies and conditions. Through this producer-consumer interaction, the SMF 114 and PCF 130 collaborate to deliver efficient and reliable service within the 5G network architecture.

As those skilled in the art readily appreciate, various NFs may act as producer NFs and consumer NFs. For example, a producer NF may be or include the PCF 130, the SMF 114, the UDR 134, a charging function (CHF), Binding Support Function (BSF) (not shown), or a Network Data Analytic Function (NWDAF) (not shown). depending on the operation and the service request. A consumer NF may be or include the UE 104, a service capability function (SCF) (not shown), the SCP 122, the SMF 114, the AMF 112, the NEF 126, a security edge protection proxy (SEPP) 136, the UDR 134, or a charging function (CHF), depending on the operation and the service request.

To facilitate service routing between consumer NFs and producer NFs, the NRF 128 identifies and aids in the discovery of NF profiles that meet the service routing needs of respective consumer NFs within the 5G core network. Acting as a centralized registry, the NRF 128 maintains detailed profiles of all registered NFs, encompassing essential attributes such as locality, load, capacity, and priority. When a consumer NF, such as an SMF 114 or AMF 112, initiates a service request, the NRF 128 dynamically filters and returns a list of discoverable NFs that align with the specified parameters. For example, if an SMF 114 seeks a PCF 130 to apply policy and QoS rules, the NRF 128 can prioritize PCF 130 instances within the same locality to reduce latency, while also considering the load and capacity of each candidate to ensure the selected NF can handle the incoming session without degradation. This streamlined discovery process accelerates service routing and ensures that critical functions are matched with NFs capable of meeting the operational demands of the network.

Beyond locality and load, the NRF 128 also assesses capacity and priority metrics during NF discovery, ensuring the robustness of NF selection. Capacity reflects the NF's ability to manage additional workloads, factoring in elements such as processing power, memory, and concurrent session limits. By evaluating real-time capacity data, the NRF 128 helps prevent overburdening NFs that may otherwise struggle to fulfill new requests. Priority, on the other hand, dictates the precedence of certain NFs over others, allowing the NRF 128 to prefer highly resilient or strategically deployed NFs for mission-critical tasks. The NRF's 128 role extends across various NF interactions, supporting use cases like the AMF 112 selecting an SMF 114, the PCF 130 routing to a BSF, or even the NSSF 124 interfacing with the NEF 126, highlighting its central function in sustaining seamless service orchestration throughout the 5G core network.

As outlined above, a limitation of current approaches to service routing and NF selection lies in the lack of transparency of whether or not a respective NF set is operating above its minimum availability threshold. Traditionally, a consumer NF selects an instance within a NF set based solely on the instance's discovery parameters (e.g., locality, capacity, load). However, as noted above, these parameters do not account for the respective NF set's fault tolerance. This absence of fault tolerance awareness leads to potential issues when a consumer NF selects an instance for service routing that fails or operates suboptimally, compromising the overall reliability and performance of the 5G network 100. Furthermore, the lack of visibility into the dynamic status of the NF set may prevent the 5G network 100 from adapting to unforeseen failures, resulting in degraded user experience or system downtime.

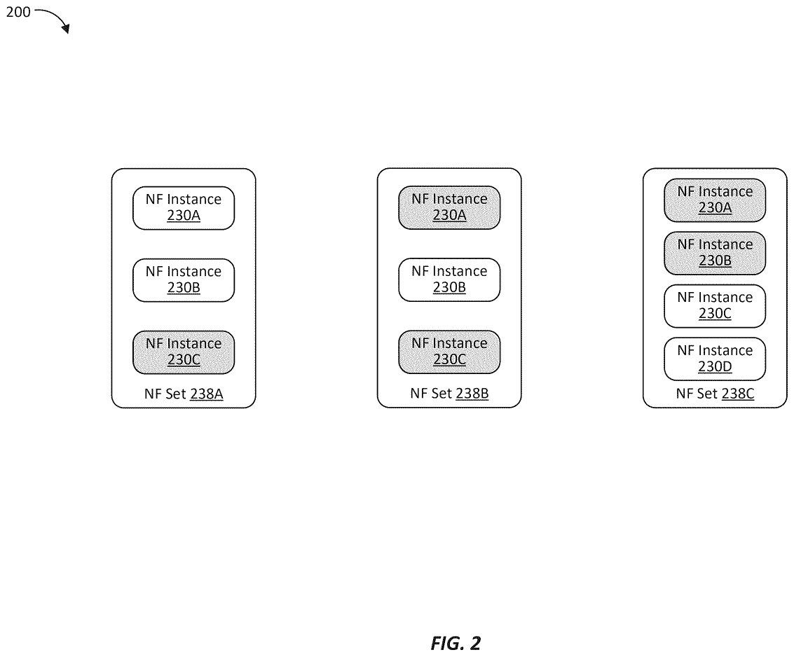

To further highlight the issues caused by conventional frameworks, FIG. 2 provides an example environment 200 including three NF sets 238A-C having varied minimum availability thresholds, according to an embodiment herein. For ease of illustration, FIG. 2 is described in the context of a 5G network environment, such as the 5G network 100, however, it should be appreciated that the following is equally applicable to other networks, such as a 4G network utilizing 5G network functions.

As illustrated, each NF set 238A-C consists of multiple NF instances 230A-D, which may include producer NF instances, such as a PCF instance. Specifically, NF set 238A contains three NF instances (230A-C), NF set 238B also includes three NF instances (230A-C), and NF set 238C comprises four NF instances (230A-D). In this context, an “instance” refers to a single, operational deployment—either software or hardware—of a particular NF type, such as the PCF 130, running in a specific location or cluster. Each instance operates with its own resources, capacity, and operational state. Consequently, each NF instance 230A-D within a given NF set 238A-C has its own resources and capacity to handle requests from consumer NFs, independently managing the load and service allocation.

To ensure flexibility, resiliency, and efficiency within the network 100, NF consumers (not shown) strategically distribute service loads across multiple NF sets 238A-C. Each NF set 238A-C contains multiple NF instances 230A-D, which replicate session information within the same set. This redundancy guarantees that if one NF instance 230A-D within a given NF set fails, the remaining instances can retain the session information and continue processing requests without disruption. To further mitigate the risk of a complete NF set 238A-C becoming unavailable—due to localized failures or other disruptions—the consumer NFs enhance resiliency by routing service requests to NF instances 230A-D deployed across multiple NF sets 238A-C, often within the same locality. This distribution allows NF consumers to dynamically allocate service loads, ensuring balanced resource utilization across the network. By leveraging this multi-set deployment, the network can seamlessly redirect service requests to available NF instances 230A-D from different NF sets, ensuring uninterrupted service and protecting against both instance-level and set-level failures. This layered resiliency approach combines intra-set redundancy with inter-set failover, delivering robust and reliable service continuity.

To further enhance network resiliency, vendors and operators define fault tolerance policies that specify the minimum number of available instances 230A-C, D required in the NF sets 238A-C to continue accepting service requests, which is referred to herein as the minimum availability threshold. These minimum availability thresholds ensure that each NF set 238A-C can maintain operational capacity, even in the event of instance failures. The minimum availability threshold is typically based on the criticality of the services provided by the NF set 238A-C, as well as the expected workload and redundancy requirements. For example, the minimum availability threshold for each of the NF sets 238A-C may be 2, meaning that to continue accepting service routing, the respective NF set 238A-C requires at least two out of three instances 230A-C, D to be operational. If the number of available instances falls below this threshold, the NF set 238A-C is considered unavailable for servicing new sessions, and the consumer NFs are triggered to route requests to instances in other NF sets. This approach allows the network to maintain service continuity by ensuring that only NF sets with sufficient operational capacity are used, while also preventing the routing of traffic to overburdened or unreliable NF sets. By defining fault tolerance in terms of a minimum number of operational instances, vendors and operators can better safeguard against disruptions, optimizing the balance between resiliency and resource utilization across the network.

To further illustrate the minimum availability threshold, the greyed NF instances indicate failed or unavailable NF instances. As shown, the NF instance 230C in NF set 238A is unavailable, the NF instances 230A and 230C of NF set 238B are unavailable, and the NF instances 230A-B of the NF set 238C are unavailable. If the minimum availability threshold for each of the NF sets 238A-C is two, following the above example, then the NF sets 238A and 238C may continue to receive service routing, since each NF set 238A and 238C have two available NF instances (230A-B and 230C-D, respectively). NF set 238B, however, may no longer accept new service requests from the NF consumer due to not having enough available NF instances (only NF instance 230B is available).

Since the environment 200 is dynamic in nature, the availability of instances within the NF sets 238A-C may be continuously changing. As such, NF consumers may continue to route traffic to an NF set, such as the NF set 238B even after the number of available instances 230A-C fall below the minimum availability threshold. For example, a consumer NF may be routing services to the NF instance 230A of the NF set 238A, when the NF instance 230A suddenly goes down. Under conventional approaches, the consumer NF would continue to route services to another instance, here the NF instance 230B, within the same NF set 238A. However, because the NF set 238A no longer has a satisfied minimum availability threshold, the services would be rerouted, causing the negative consequences outlined above.

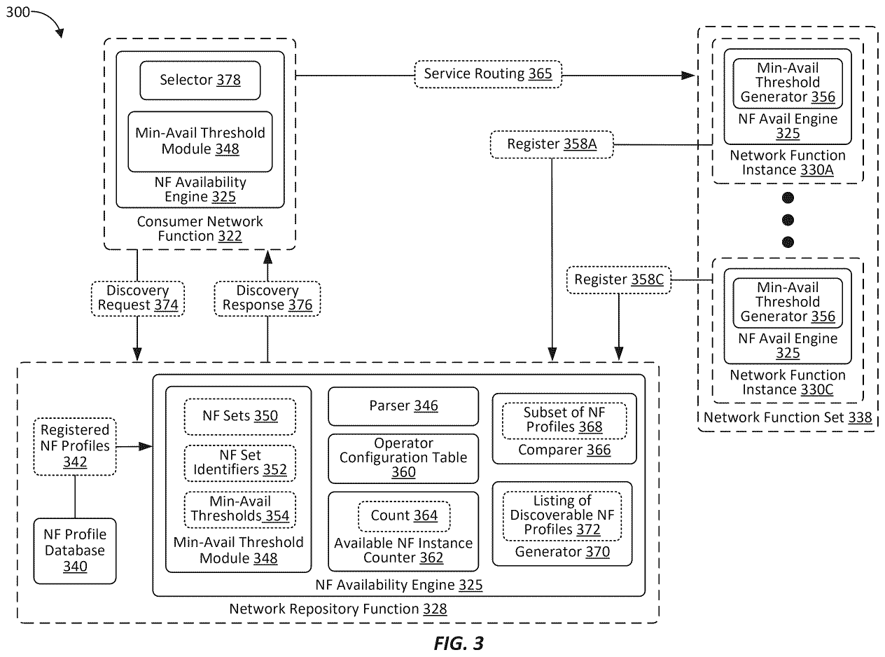

To address at least the above shortcomings of conventional network frameworks, an example NF availability engine is provided herein. Referring now to FIG. 3, an operational environment 300 including an NF availability engine 325 is illustrated, according to an embodiment herein. As shown, the NF availability engine 325 may include a consumer-side, a producer-side, and/or an NRF-side. That is, one or more functions of the NF availability engine 325 may be performed by a consumer NF 322, which may be the same or similar to the SCP 122, one or more functions may be provided by producer NF instances 330A-C, which may be the same or similar to the PCF 130, while one or more functions may be performed by a NRF 328, which may be the same or similar to the NRF 128.

It should be appreciated, that while the following discussion is focused on the illustrated arrangement of the NF availability engine 325, in some embodiments, one or more of the illustrated components/functions of the NF availability engine 325 may be arranged differently. For example, in some embodiments, the NF availability engine 325 may be hosted separately from the consumer NF 322, the producer NF instances 330A-C, and/or the NRF 328, such as by a third party or another NF. Furthermore, in some embodiments the NF availability engine 325 may be in operational communication with the NRF 328 and/or in operational communication with the consumer NF 322, depending on the application.

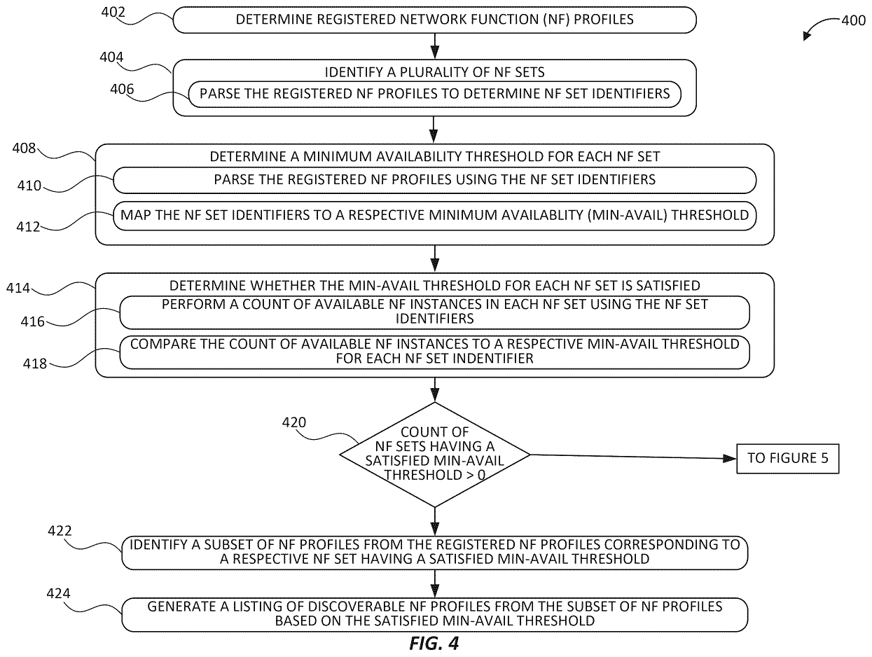

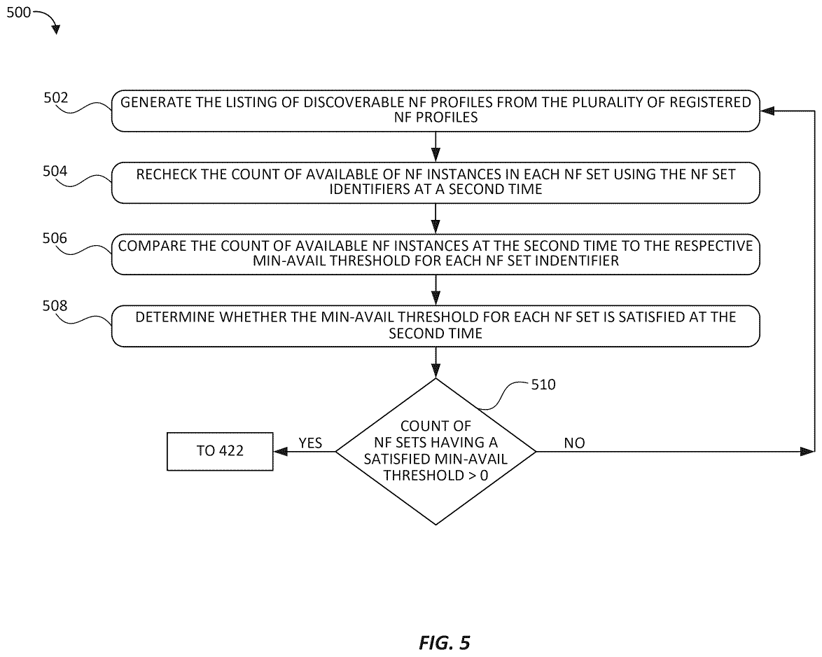

For ease of explanation, FIG. 3 is described in conjunction with FIGS. 4-7, which provide various example NF availability engine processes, according to various embodiments herein. Initially FIG. 3 is discussed with respect to FIG. 4, which illustrates a process 400 for providing the NF availability engine 325 and one or more of its functions, and then with respect to the FIGS. 5-7. While FIGS. 4-7 are described with relation to FIG. 3, it should be appreciated that components, elements, and steps from any other Figures described herein may be equally applicable.

With reference to FIG. 3, the environment 300 includes the consumer NF 322, a producer NF instances 330A-C, and a NRF 328. The consumer NF 322 may be an NF that routes service requests/updates, such as the SCP 122 or the SMF 114. As such, the consumer NF 322 may perform NF selection to identify an appropriate NF for handling specific requests/updates. To support identification of appropriate NFs, the consumer NF 322 communicates with a NRF 328. The NRF 328 acts as a centralized registry for all NFs, maintaining real-time information of respective NF capabilities. As illustrated, the NRF 328 includes a profile database 340 that stores information about registered NFs, including their type, capabilities, supported services, geographical locations, current load status, and capacities.

The environment 300 also includes a NF set 338 containing NF instances 330A-C. It should be appreciated that while the illustrated example only includes a single NF set 338, any number of NF sets may be present within the environment 300. Similarly, while the NF set 338 is depicted as including three NF instances 330A-C, the NF set 338 may include any number of NF instances 330A-C. The number of NF sets 338 and NF instances 330A-C are limited for ease of illustration.

As shown, the NRF 328 includes the NF availability engine 325, also referred to herein as the NRF-side engine 325. The NRF-side engine 325 may perform one or more steps of the process 400 illustrated in the FIG. 4. To initiate the process 400, the NRF-side engine 325 determines NF profiles registered with the NRF 328 (402). For example, the NRF 328 may query the NF profile database 340 to determine registered NF profiles 342. As those skilled in the art readily appreciate, the registered NF profiles 342 include various information about a respective NF instance, such as its type, capabilities, location, health status, and resource availability.

The registered NF profiles 342 also contain information about the specific NF sets to which each NF instance belongs. This enables the NRF-side engine 325 to identify a plurality of NF sets 350 corresponding to the registered NF profiles 342 (404). The NRF-side engine 325 includes a minimum availability (min-avail) threshold module 348, which evaluates these profiles to determine the NF sets 350 that meet the required availability criteria. To associate each registered NF profile 342 with its corresponding NF set 350, the NRF-side engine 325 utilizes a parser 346. This parser 346 scans the registered NF profiles 342 to extract the NF set identifiers 352 (406), which are embedded within each NF profile 342. These NF set identifiers 352 serve as a unique reference, linking each NF instance to the specific NF set 350 it is part of. As those skilled in the art readily appreciate, a single NF instance, such as NF instance 330A, may be part of more than one NF set. In such cases, the NF instance 330A may register multiple NF profiles 342 with the NRF 328, each containing a respective NF set identifier 352 corresponding to its membership in a different NF set or may register a single NF profile 342 containing multiple NF set identifiers 352. The NF set identifiers 352 allow the NRF 328 to track each instance's availability and characteristics within the context of a respective NF set it belongs to, facilitating more flexible and efficient service routing and resource management across different sets.

Once the NF sets 350 are identified, the min-avail threshold module 348 determines the min-avail thresholds 354 for each NF set 350 (408). As will be described in greater detail in the following discussion, each of the registered NF profiles 342 may include a min-avail threshold 354 for a respective NF set that the registering NF instance is associated with. As such, NRF-side engine 325 parses each of the registered NF profiles 342 using the parser 346 to identify the min-avail thresholds 354 for each NF set 350 (410). In particular, the min-avail threshold module 348 uses the NF set identifiers 352 to map a respective min-avail threshold 354 to a respective NF set 350 (412). In some cases, the min-avail threshold module 348 generates a map using the NF set identifiers 352 as the key to track the min-avail thresholds 354 for each respective NF set 350.

As noted above, each of the NF instances 330A-C within the NF set 338 register with the NRF 328. For example, upon deployment the NF instance 330A registers 358A its respective NF profile with the NRF 328. Similarly, the NF instance 330C registers 358C its respective NF profile with the NRF 328. As part of each registered NF profile 342, the NF instances 330A,C include the NF set identifier for the NF set 338 and any other NF sets to which the NF instances 330A,C are part of, along with operational parameters, such as capacity, load, locality, and the like.

In some embodiments, the NF instances 330A-C may include NF availability engines 325 that are either running locally on each respective instance or in operational communication with them. These instance-side NF availability engines 325, herein after instance-side engines 325, include a min-avail threshold generator 356. The min-avail threshold generator 356 may generate and publish a respective min-avail threshold 354 for each respective NF instance 330A-C as part of the registered NF profile 342. As noted above, the min-avail threshold 354 is defined by the fault tolerance for the NF set 338. The fault tolerance may be set by a vendor or operator prior to or upon deployment of the NF set 338. As such, the min-avail threshold generator 356 may receive the input from the vendor or operator for the NF set 338 and generate vendor-specific extensions, as allowed by 3GPP Technical Specification 29.500—section 6.6.3, to be included in the NF profile identifying the min-avail threshold 354 for each respective NF instance 330A-C.

The following is an example min-avail threshold that may be provided using vendor-specific extensions within an NF profile for an NF instance, such as the NF instance 330A:

```
“vendorSpecific-000111”: {
  “version”: 1,
  setCriteria: [{setID: “set1”, minAvailableInSet: 1},
    { setID: “set2”, minAvailableInSet: 2} ]
}
```

In the above example, the setID identifies the NF set identifiers 352 set1 and set2 of the NF sets that the NF instance is associated and the minAvailableInSet defines the min-avail thresholds 354 for each respective NF set. As shown, the min-avail threshold 354 for set1 is 1 and the min-avail threshold 354 of set 2 is 2. When the NRF-side engine 325 parses the registered NF profile 342 containing this vendor-specific extension, the min-avail threshold module 348 maps the min-avail threshold 354 of 1 to set1 and the min-avail threshold 354 of 2 to the set2.

In some embodiments, instead of the NF instances 330A-C updating their respective NF profiles 342 to include the min-avail thresholds 354, the NRF-side engine 325 includes an operator configuration table 360. In such cases, the operator configuration table 360 includes a table identifying and specifying the min-avail thresholds 354 for each NF set based on the NF set identifier 352. Table 1 provides an example operator configuration table 360 following the example from above:

TABLE 1

| NF SET IDENTIFIER | MIN-AVAIL THRESHOLD |
|---|---|
| (SETID) | (MINAVAILABLEINSET) |
| set1 | 1 |
| set2 | 2 |

In scenarios where the NRF-side engine 325 leverages the operator configuration table 360 to determine the min-avail thresholds 354, the min-avail threshold module 348 queries the operator configuration table 360 with a respective NF set identifier 352 to determine the min-avail threshold 354 for that NF set. An operator or vendor associated with the NF instances 330A-C and/or the NRF 328 may define and update the min-avail thresholds 354 within the operator configuration table 360 for each NF set 338 within a respective network. It should be appreciated that while the operator configuration table 360 is illustrated as part of the NRF-side engine 325, in some cases, the operator configuration table 360 may be hosted separately from the NRF-side engine 325, such as part of the NRF 328 or a third party.

Once the NRF-side engine 325 identifies the min-avail thresholds 354 for each of the NF sets 350, the NRF-side engine 325 then determines whether the min-avail threshold 354 for each NF set 350 is satisfied (414). To determine whether a respective min-avail threshold 354 is identified, the NRF-side engine 325 performs a count of available NF instances in each NF set 350 using the NF set identifiers 352 (416). In particular, the NRF-side engine 325 includes an available NF instance counter 362 that performs a count 364 of available NF instances within each respective NF set 350. To perform the count 364, the available NF instance counter 362 analyzes the registered NF profiles 342 and identifies NF profiles associated with available NF instances using NF set identifiers 352. In other words, the available NF instance counter 362 maps a number of available NF instances to each NF set 350 using the NF set identifiers 352. In some embodiments, this may be an iterative process where the NRF-side engine 325 goes through the registered NF profiles 342 on a NF set identifier 352 basis, generating the count 364 of available NF instance for each NF set 350 per pass.

Responsive to performing the count 364, the NRF-engine 325 then compares the count 364 of available NF instances to the min-avail threshold 354 for each respective NF set 350 (418). In particular, the NRF-side engine 325 includes a comparer 366 that iterates through the NF set identifiers 352 to compare the min-avail thresholds 354 to the respective counts 364. Again, this may be performed on an iterative basis. If the comparer 366 identifies an NF set 350 having a count 364 lower than the min-avail threshold 354 for that respective NF set 350, the NRF-side engine 325 identifies the NF profiles associated with the NF set identifier 352 for that NF set 350. The NRF-side engine 325 then identifies these NF profiles as having an unsatisfied min-avail threshold. In contrast, if the comparer 366 determines that the count 364 for a respective NF set 350 is above or exceeds the min-avail threshold 354 for that NF set, the NRF-side engine 325 then identifies the NF profiles associated with the NF set identifier 352 as having a satisfied min-avail threshold. In some cases, the NRF-side engine 325 identifies the respective NF profiles using NF identifiers defined within each NF profile.

Once the comparer 366 compares the counts 364 to the min-avail thresholds 354 for each NF set identifier 352, the NRF-side engine 325 then determines whether the count of NF sets 350 having a satisfied min-avail threshold is greater than zero (420). If the number of NF sets 350 having a satisfied min-avail threshold is greater than zero, the NRF-side engine 325 then identifies a subset of NF profiles or NF instances 368 (herein after NF profiles for ease of explanation) from the registered NF profiles 342 associated with the NF sets 350 having a satisfied min-avail threshold (422). Using the subset of NF profiles 368, the NRF-side engine 325 generates a listing of discoverable NF profiles 372 (424). In particular, the NRF-side engine 325 includes a generator 370 that generates the listing of discoverable NF profiles 372 that have satisfied min-avail thresholds.

In contrast, if the NRF-side engine 325 determines that the number of NF sets 350 having a satisfied min-avail threshold is zero (420), then the NRF-side engine 325 may perform one or more of the functions provided in FIG. 5. FIG. 5 illustrates an example process for providing one or more functions of the NRF-side engine 325, according to an embodiment herein. Once the NRF-side engine 325 determines that none of the NF sets 350 identified from the registered NF profiles 342 have a satisfied min-avail threshold, the NRF-side engine 325 then generates the listing of discoverable NF profiles 372 from the registered NF profiles 342 (502). As can be appreciated, if none of the NF sets 350 are operating above the min-avail threshold 354, it is preferable to route service requests to the best available NF instances, even if the min-avail threshold 354 is not fully met, to ensure continued network operation and minimize service disruption. As such, the listing of discoverable NF profiles 372 is generated to include the registered NF profiles 342, regardless if they have a satisfied min-avail threshold 354 in scenarios where no NF sets 350 have a satisfied min-avail threshold.

Given the dynamic nature of the network and the continuously changing operational status and capacity of NF instances 330A-C, the NRF-side engine 325 actively monitors the registered NF profiles 342 to recheck the count 364 for each NF set 350 (504). For example, each NF instance 330A-C may periodically send heartbeat signals to the NRF 328 to report its health and availability. If the NRF 328 stops receiving heartbeat signals from an NF instance, it may interpret this as an indication that the instance is unavailable or out of service. In response, the NRF 328 updates the corresponding NF profile 342 to reflect the instance's new status. Conversely, if a previously unavailable NF instance 330A-C resumes operation and begins sending heartbeat signals again, the NRF 328 updates its NF profile 342 to indicate that the instance is now available for service. As such, when the NRF-side engine 325 rechecks the count 364 for each NF set 350 by performing a count of available NF instances for each NF set identifier 352, as described above.

Responsive to the recount, the NRF-side engine 325 then compares the count of available NF instances performed at this subsequent time to the respective min-avail thresholds 354 for each NF set 350 (506). Then, based on this comparison, the NRF-side engine 325 determines whether the min-avail threshold 354 for each NF set 350 is satisfied at this subsequent time (508). If the NRF-side engine 325 determines that the count of NF sets 350 having a satisfied min-avail threshold is greater than zero (510), then the process continues to step 422 described above. In contrast, if the NRF-side engine 325 again determines that the number of NF sets 350 having a satisfied min-avail threshold is zero, then the process loops back to step 502, where the NRF-side engine generates the listing of discoverable NF profiles 372 using the registered NF profiles 342. By continuously looping through these steps, the NRF-side engine 325 generates and updates the listing of discoverable NF profiles 372 in real-time so that if and when the consumer NF 322 submits a discovery request 374, the NRF-side engine 325 can identify NF profiles having satisfied min-avail thresholds from the listing 372.

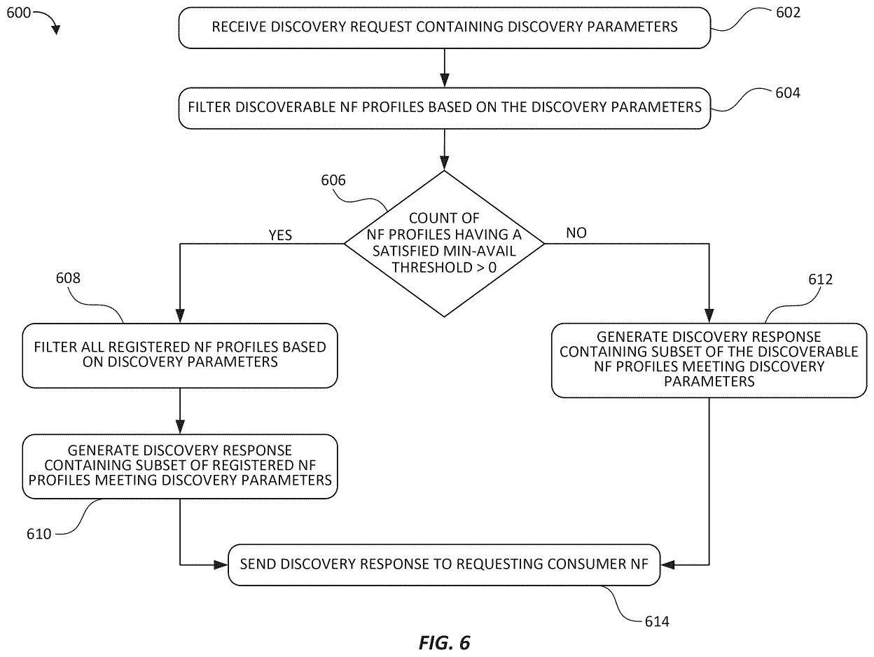

With reference now to FIG. 6, an example process 600 for generating a discovery response is illustrated, according to an embodiment herein. As noted above, FIG. 6 is described with respect to FIG. 3 as well. As such, with reference to FIG. 3, the consumer NF 322 submits the discovery request 374 to the NRF 328 to identify potential NF instances for handling service routing. Since the NRF-side engine 325 is in operable communication or executed locally by the NRF 328, when the discovery request 374 is received by the NRF 328, the NRF-side engine 325 may also receive the discovery request 374 (602). The discovery request 374 includes a variety of discovery parameters, outlining the NF type, locality, and service capabilities required for efficient service routing. These discovery parameters help the NRF 328 to identify NF instances that meet the specified criteria, ensuring that service requests are directed to the most suitable and available NFs.

Responsive to receiving the discovery request 374, the NRF-side engine 325 filters the listing of discoverable NF profiles 372 based on the discovery parameters (604). As noted above, by filtering based on the discovery parameters, the NRF-side engine 325 identifies NF instances that meet the requested criteria for the service request. Once the discoverable NF profiles are filtered, the NRF-side engine 325 determines whether the count of NF profiles having a satisfied min-avail threshold is greater than zero (606). As can be appreciated, the listing of discoverable NF profiles may include NF instances 330A-C that have a satisfied min-avail threshold, however, none of these NF instances 330A-C may meet the discovery parameters outlined in the discovery request 374. In such cases, the NRF-side engine 325 then filters the registered NF profiles 342 based on the discovery parameters to identify NF instances that meet the requested criteria (608). Based on filtering of the registered NF profiles 342, the NRF-side engine 325 then generates a discovery response 376 containing the subset of registered NF profiles 342 meeting the discovery parameters (610).

In contrast, however, if the NRF-side engine 325 filters the discoverable NF profiles having satisfied min-avail thresholds and determines that a subset of those discoverable NF profiles meet the discovery parameters, the NRF-side engine 325 then generates the discovery response 376 containing this subset of discoverable NF profiles meeting the discovery parameters (612). Once generated, the NRF-side engine 325, via the NRF 328, transmits the discovery response 376 to the consumer NF 322 (614).

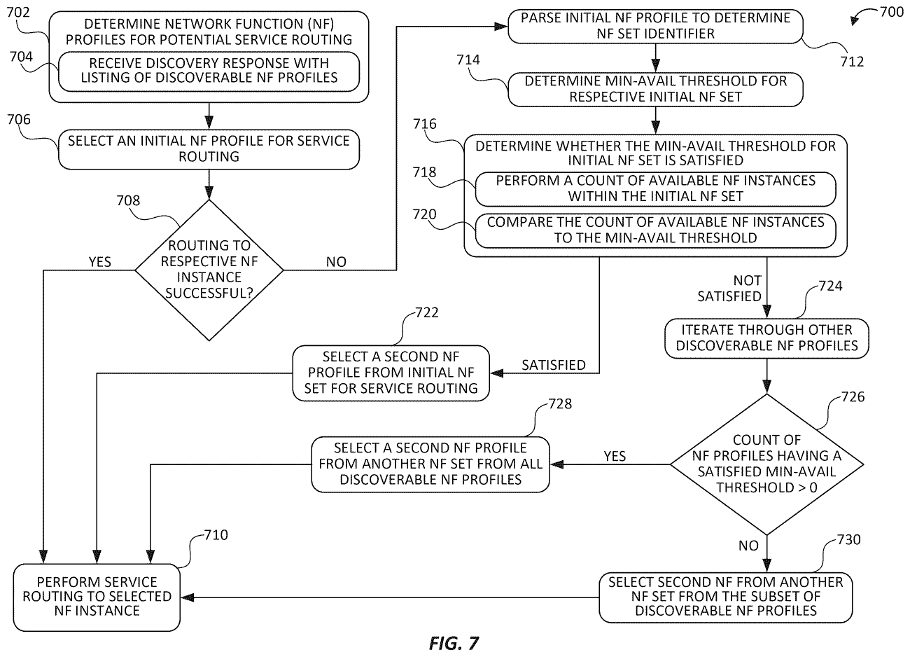

As illustrated in FIG. 3, in some embodiments, the consumer NF 322 may be in operational communication with an NF availability engine 325, referred to herein as consumer NF-side engine 325. In such cases, the consumer NF-side engine 325 may perform one or more of the functions outlined in FIG. 7 subsequent to receiving the discovery response 376. With reference to FIG. 7, a flow 700 for providing one or more functions of the consumer NF-side engine 325 is provided, according to an embodiment herein. FIG. 7 is described with reference to FIG. 3, however, it should be appreciated that it is equally applicable to other Figures herein.

With reference to FIG. 3, the consumer NF 322 may determine NF profiles of potential service routing (702). For example, the consumer NF 322 may parse the subset of NF profiles provided in the discovery response 376 to determine one or more NF profiles for potential service routing (704). From the NF profiles identified for potential service routing, the consumer NF-side engine 325 selects an initial NF profile for service routing (706). For example, the consumer NF-side engine 325 may select The NF instance 330A based on its NF profile and the requirements of the service routing 365. Once selected, the consumer NF 322 may attempt the service routing 365. Responsive to initiation of the service routing 365, the consumer NF-side engine 325 may determine whether or not the routing was successful (708). If the routing was successful, the consumer NF-side engine 325 may allow the service routing 365 to continue without taking further action (710).

However, if the consumer NF-side engine 325 determines that the service routing 365 to the NF instance 330A is not successful, the consumer NF-side engine 325 performs one or more additional steps to identify a subsequent NF profile for service routing. Unlike conventional frameworks where upon a failed service routing the consumer NF 322 prioritizes selection of another NF instance (e.g., 330B) from the same NF set 338, the consumer NF-side engine 325 analyzes the NF set 338 to ensure that the minimum availability threshold 354 is satisfied in view of the NF instance 330A being currently unavailable. As noted above, if the NF set 338 has an unsatisfied minimum availability threshold, then the network may reroute traffic to any subsequently selected NF instances from the NF set 338 which may negatively impact the overall service performance, increase latency, or lead to potential service degradation due to overloaded or partially available instances.

In particular, responsive to determining that the routing was unsuccessful, the consumer NF-side engine 325 parses the initial NF profile associated with the NF instance 330A to determine its respective NF set identifier 352 (712). Then, using the NF set identifier 352, the consumer NF-side engine 325 determines the min-avail threshold 354 for the respective NF set, here the NF set 338 (714). Then the consumer NF-set 338 determines whether the min-avail threshold 354 is satisfied (716). To determine whether the min-avail threshold 354 for the NF set 338 is satisfied, the consumer NF-side engine 325 performs a count of available NF instances within the NF set 338 based on the NF profiles received in the discovery response 376 (718), and then compares the count to the min-avail threshold 354 (720). If the min-avail threshold 354 for the NF set 338 is satisfied, the consumer NF-side engine 325 then selects a second NF profile from the initial NF set for service routing (722) and then notifies the consumer NF 322 to perform the service routing 365 with the respective NF instance associated with the second NF profile (710).

However, if the consumer NF-side engine 325 determines that the min-avail threshold 354 for the NF set 338 is not satisfied, the consumer NF-side engine 325 iterates through the other discoverable NF profiles provided in the discovery response 376 (724) to determine other NF sets 350, their respective min-avail thresholds 354, and whether there are any other NF sets that have a satisfied min-avail threshold. If the number of NF profiles having a satisfied min-avail threshold is greater than zero (726), the consumer NF-side engine 325 then selects a second NF profile from the discoverable NF profiles provided in the discovery response 376 based on the discovery parameters for the service routing 365.

In contrast, if the consumer NF-side engine 325 determines that none of the NF profiles provided in the discovery response 376 have a satisfied min-avail threshold, the consumer NF-side engine 325 then selects a second NF from another NF set for servicing the new session request (730). In such cases, the consumer NF-side engine 325 determines whether to select a second NF from the same NF set or from a different NF set. This determination may be made based on the min-available instances in each respective NF set. As can be appreciated, the scenarios where no NF sets are operating above their min-avail thresholds are likely to indicate cross network NF instance failure, meaning it would be better to route services to any available NF instances regardless of its fault tolerance than fail to route the service at all. As such, the consumer NF-side engine 325 selects an NF instance from the discovery response 376 to avoid complete service failure (of a new session) during network issues where NF sets have unsatisfied min-available thresholds. In other words, if NF sets are struggling to satisfy their respective min-avail thresholds 354, the consumer-NF side engine 325 avoids triggering denial-of-service due to the fault tolerance constraint by selecting an available NF instance within any NF set to keep the network functional.

Once the selection is made, the consumer NF-side engine 325 notifies the consumer NF 322 to perform the service routing 365 with the respective NF instance associated with the second NF profile (710). In this manner, the consumer NF-side engine 325 prioritizes NF instances that are part of NF sets having satisfied min-avail thresholds, thereby improving overall service performance, decreasing latency, and protecting against potential service degradation due to selection of overloaded or partially available instances.

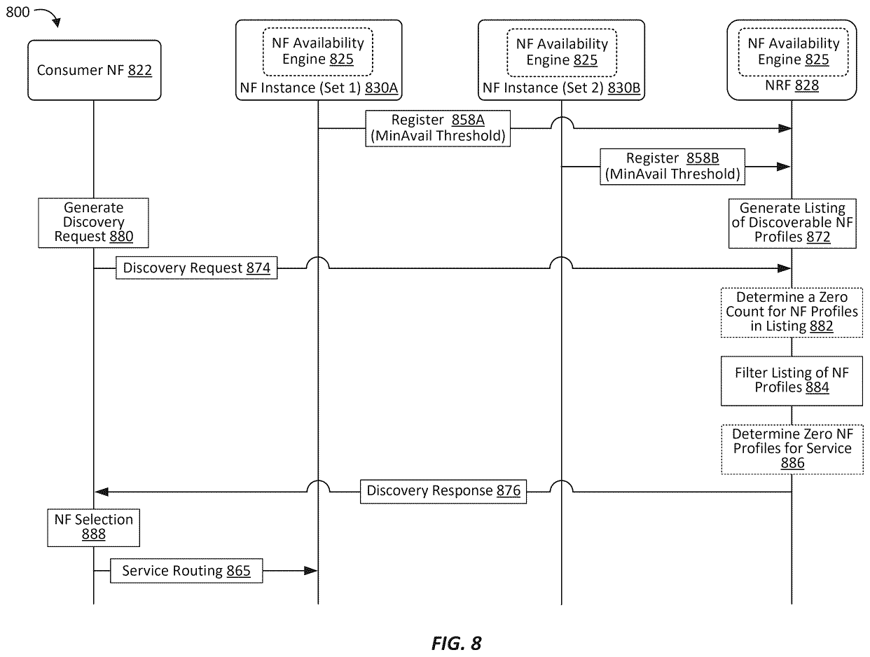

Referring now to FIG. 8, an example flow 800 for providing an NF availability engine 825 is illustrated, according to an embodiment herein. As shown, the flow 800 includes a consumer NF 822, which may be the same or similar to the consumer NF 322, NF instances 830A-B, which may be the same or similar to the NF instances 330A-C, and an NRF 828, which may be the same or similar to the NRF 328. The NF instance 830A is part of a first NF set and the NF instance 830B is part of a second NF set. Upon deployment or update, each of the NF instances 830A-B may register the min-avail threshold for their respective NF set (858A-C). In particular, the NF instance 830A includes an NF availability engine 825 that generates the vendor-specific extensions that include the NF set identifier for the first NF set and its respective min-avail threshold. Similarly, the NF instance 830B includes an NF availability engine 825 as well that also generates the vendor-specific extensions to include the NF set identifier for the second NF set and its respective min-avail threshold.

As described above, these vendor-specific extensions are included in each NF instances' 830A-B respective NF profile such that when the NF profile is registered (858A-B) with the NRF 828, the NF availability engine 825 associated with the NRF 828 (hereinafter the NRF-side engine 825) can use this information to identify NF profiles having satisfied min-avail thresholds. In particular, the NRF-side engine 825 generates a listing of discoverable NF profiles (872) using the NF set identifiers and the min-avail thresholds outlined in the vendor-specific extensions of the NF instances' 830A-B respective NF profiles.

At some point, the consumer NF 822 generates a discovery request to identify an appropriate NF instance for service routing (880). Once generated, the consumer NF 822 transmits the discovery request to the NRF 828 (874). If at the time that the NRF 828 receives the discovery request, the NRF-side engine 825 determines a zero count of NF profiles having a satisfied min-avail threshold within the listing (882), the NRF-side engine 325 then selects all NF profiles registered with the NRF 828 for the subsequent steps. In contrast, if there are NF profiles having a satisfied min-avail threshold within the listing of discoverable NF profiles, the NRF-side engine 325 uses these for the subsequent steps.

As described above, the discovery request includes discovery parameters that outline the specific criteria of a NF instances needed for the service routing. As such, the NRF-side engine 825 may filter the listing of discoverable NF profiles or all the registered NF profiles, depending on the count of the listing, based on the discovery parameters (884). If the NRF-side engine 825 determines a zero count of NF profiles meeting the discovery parameters within the listing after filtering based on the discovery parameters (886), the NRF-side engine 825 then selects all NF profiles registered with the NRF 828 and filters again based on the discovery parameters. In contrast, if the NRF-side engine 825 identifies one or more NF profiles that have a satisfied min-avail threshold and meet the discovery parameters, the NRF-side engine 825 identifies these NF profiles for the discovery response.

Once the NRF-side engine 825 identifies one or more NF profiles that meet the discovery parameters, either from the listing of discoverable parameters if the count is above zero or from all registered NF profiles, the NRF-side engine 825 generates and sends a discovery response providing the identified NF profiles to the consumer NF 822 (876). Responsive to receiving the discovery response, the consumer NF 822 performs NF selection (888) and performs service routing to the selected NF instance (865).

In some embodiments, after the consumer NF 822 performs NF selection, a NF availability engine executed on a SCP (hereinafter SCP-side NF availability engine) associated with the consumer NF 822 may validate the selection before completing the service routing. (not shown) As those skilled in the art readily appreciate, in some network architectures, the SCP performs service routing on behalf of the consumer NF 822. In such scenarios, an NF availability engine executing on the SCP may validate that the first NF has a satisfied min-avail threshold prior to routing the service to the NF instance 830A. This validation process includes one or more steps as described above with respect to the NRF-side NF availability engine 825 determining whether or not a respective NF set contains a satisfied min-avail threshold.

If the SCP-side availability engine determines that the first NF set has a satisfied min-avail threshold, the SCP-side availability engine routes the service to the first NF instance 830A as selected by the consumer NF 822. In contrast, however, if the SCP-side availability engine determines that the first NF set has an unsatisfied min-avail threshold, the SCP-side availability engine may parse the other NF profiles identified in the discovery request to determine another NF set having a satisfied min-avail threshold, as described above. Once an NF instance, such as the second NF instance 830B is identified as part of a NF set having a satisfied min-avail threshold, the SCP-side availability engine may reroute the service to the second NF instance 830B.

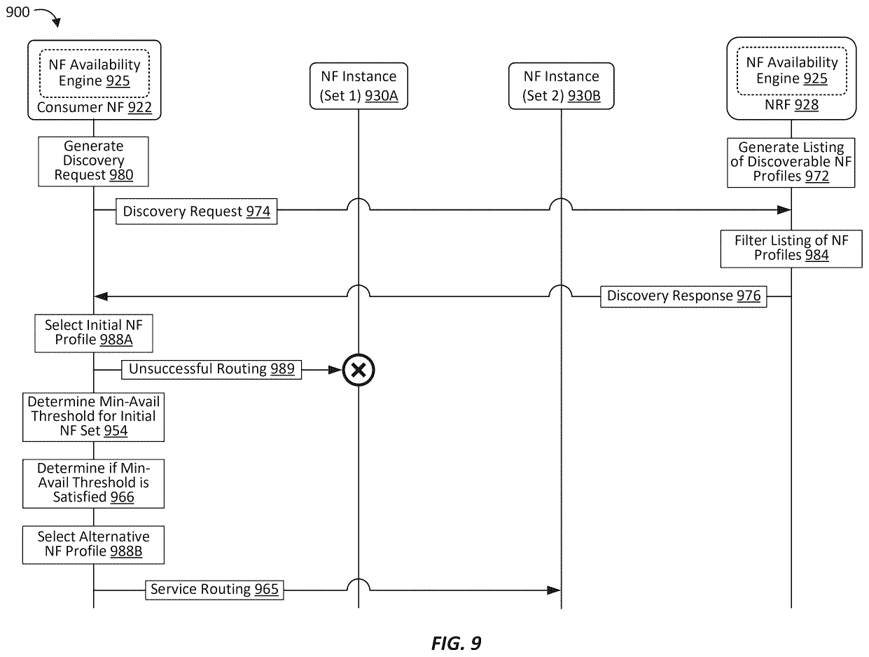

Referring now to FIG. 9, an example flow 900 for providing one or more functions an consumer NF-side availability engine 925 is illustrated, according to an embodiment herein. As shown, a consumer NF 922 is in operational communication with a NF availability engine 925, referred to hereinafter as the consumer NF-side engine 925, which may be the same or similar to the consumer NF 322 and the consumer NF-side engine 325, respectively. The consumer NF 922 generates a discovery request (980) and sends the discovery request to an NRF 928 to identify potential producer NFs or NF instances for handling a service request (974).

As shown, the NRF 928, which may be the same or similar to the NRF 328, also includes an NF availability engine 925, which is referred to hereinafter as the NRF-side engine 925. As such, the NRF-side engine 925 may generate a listing of discoverable NF profiles (972) as described above. That is, the NRF-side engine 925 may parse the registered NF profiles to identify NF profiles that are part of an NF set having a satisfied min-avail threshold. As such, responsive to receiving the discovery request, the NRF-side engine 925 filters the listing of discoverable NF profiles based on the discovery parameters outlined in the discovery request (984). From the filtering, the NRF-side engine 925 identifies a subset of NF profiles that meet the discovery parameters. The NRF-side engine 925 then generates and sends a discovery response to the consumer NF 922 containing the subset of NF profiles.

Responsive to receiving the discovery response, the consumer NF 922 selects an initial NF profile (988A). However, when the consumer NF 922 attempts to route service to the initial NF instance, here the NF instance 930A, the routing is unsuccessful (989). Based on the unsuccessful routing, the consumer NF-side engine 925 determines a min-avail threshold for an initial NF set associated with the NF instance 930A (954). As described above, to determine the min-avail threshold for the NF instance 930A, the consumer NF-side engine 925 parses the initial NF profile to identify the NF set identifier of the NF set that the NF instance 930A is part of. From the NF profile the consumer NF-side engine 925 also identifies the min-avail threshold for the NF set. Using the NF set identifier, the consumer NF-side engine 925 performs a count of the NF profiles received in the discovery response to determine whether the min-threshold for that NF set is satisfied (966).

As described above, depending on whether the min-avail threshold of the initial NF set is satisfied, the consumer NF-side engine 925 selects an alternative NF profile for service routing (988B). For example, if the min-avail threshold of the initial NF set is satisfied, then the consumer NF-side engine 925 selects another NF profile of an NF instance within the initial NF set. In contrast, if the min-avail threshold of the initial NF set is not satisfied, then the consumer NF-side engine 925 identifies one or more NF profiles that are part of NF sets having satisfied min-avail thresholds for service routing. If the consumer NF-side engine 925 is unable to identifier any NF profiles having satisfied min-avail thresholds, the consumer NF-side engine 925 then makes a selection based on the NF profiles provided in the discovery response. Once the alternative NF profile is selected, the consumer NF 922 performs service routing to the alternative NF instance 930B (965).

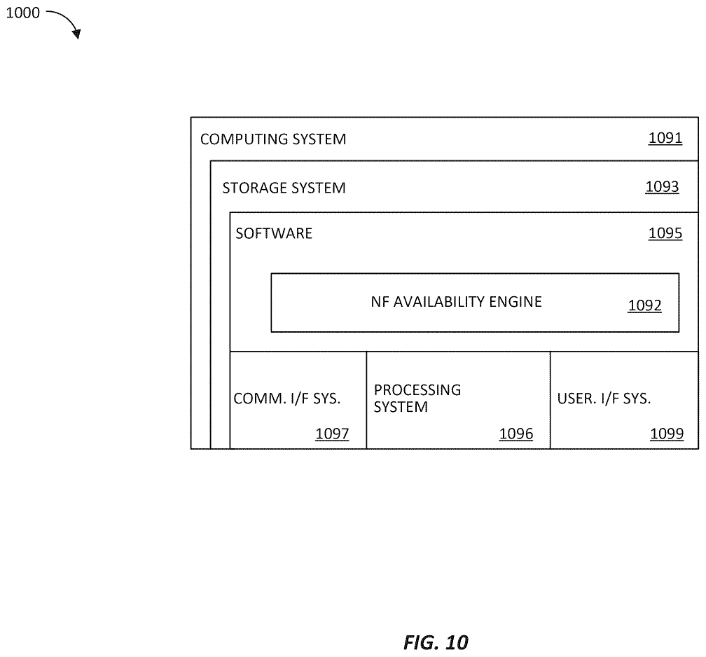

Referring now to FIG. 10, is a diagram of a system 1000 configured to implement an NF availability engine, according to an embodiment herein. The system 1000 may be an example of an apparatus including a computing apparatus 1091 that is representative of any system or collection of systems in which the various processes, systems, programs, services, and scenarios disclosed herein may be implemented. For example, computing apparatus 1091 may be an example NF availability engine, such as the NF availability engine 325/825/925, a producer NF, consumer NF, such as any NFs discussed herein, or any of the subcomponents depicted in the 5G network 100, the operational environment 300, the processes 400-700, or the operational flows 800-900, of FIGS. 1 and 3-9, respectively. Examples of computing apparatus 1091 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 1091 may be implemented as a single apparatus, system, or device or may be implemented in a distributed manner as multiple apparatuses, systems, or devices. Computing apparatus 1091 may include, but is not limited to, processing system 1096, storage system 1093, software 1095, communication interface system 1097, and user interface system 1099. Processing system 1096 may be operatively coupled with storage system 1093, communication interface system 1097, and user interface system 1099.

Processing system 1096 may load and execute software 1095 from storage system 1093. Software 1095 may include an NF availability engine 1092, which may be representative of any of the operations for providing an NF availability engine or any of its related functions, as discussed with respect to the preceding figures. When executed by processing system 1096, software 1095 may direct processing system 1096 to operate as described herein for at least the various processes, such as the processes 400-700 or any of the operational flows 800-900, operational scenarios, and sequences discussed in the foregoing implementations. Computing apparatus 1091 may optionally include additional devices, features, or functionality not discussed for purposes of brevity.

In some embodiments, processing system 1096 may comprise a micro-processor and other circuitry that retrieves and executes software 1095 from storage system 1093. Processing system 1096 may be implemented within a single processing device but may also be distributed across multiple processing devices or sub-systems that cooperate in executing program instructions. Examples of processing system 1096 may include general purpose central processing units, graphical processing units, application specific processors, and logic devices, as well as any other type of processing device, combinations, or variations thereof.

Storage system 1093 may comprise any memory device or computer-readable storage medium readable by processing system 1096 and capable of storing software 1095. Storage system 1093 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 1093 may also include computer readable communication media over which at least some of software 1095 may be communicated internally or externally. Storage system 1093 may be implemented as a single storage device but may also be implemented across multiple storage devices or sub-systems co-located or distributed relative to each other. Storage system 1093 may comprise additional elements, such as a controller, capable of communicating with processing system 1096 or possibly other systems.

Software 1095 (including the NF availability engine 1092 among other functions) may be implemented in program instructions that may, when executed by processing system 1096, direct processing system 1096 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1095 may include additional processes, programs, or components, such as operating system software, virtualization software, or other application software. Software 1095 may also comprise firmware or some other form of machine-readable processing instructions executable by processing system 1096.

In general, software 1095 may, when loaded into processing system 1096 and executed, transform a suitable apparatus, system, or device (of which computing apparatus 1091 is representative) overall from a general-purpose computing system into a special-purpose computing system as described herein. Indeed, encoding software 1095 on storage system 1093 may transform the physical structure of storage system 1093. The specific transformation of the physical structure may depend on various factors in different implementations of this description. Examples of such factors may include, but are not limited to, the technology used to implement the storage media of storage system 1093 and whether the computer-storage media are characterized as primary or secondary storage, as well as other factors.

For example, if the computer-readable storage medium is implemented as semiconductor-based memory, software 1095 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1097 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 1091 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing an NF availability engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; processor-executable instructions stored on the computer-readable storage medium; and one or more processors coupled to the computer-readable storage medium and configured to execute the processor-executable instructions to operate a network repository function (NRF) within a network, wherein the NRF comprises a network function (NF) availability engine, such that the processor-executable instructions, when executed by the one or more processors, direct the computing apparatus, to at least: determine a plurality of registered NF profiles; identify a plurality of NF sets, wherein each NF set comprises one or more NF instances, with each NF instance being associated with one or more registered NF profiles of the plurality of registered NF profiles; determine a minimum availability threshold for each NF set in the plurality of NF sets, wherein the minimum availability threshold defines a minimum number of NF instances required to maintain a fault tolerance level of the respective NF set; determine whether the minimum availability threshold in a respective NF set is satisfied; identify a subset of NF profiles from the registered NF profiles that correspond to a respective NF set comprising a satisfied minimum availability threshold; and generate a listing of discoverable NF profiles from the subset of NF profiles based on the satisfied minimum available threshold.

Example 2 is the computing apparatus of any previous or subsequent Example, wherein the processor-executable instructions to determine whether the minimum availability threshold in a respective NF set is satisfied, when executed by the one or more processors, further direct the computing apparatus to: determine a plurality of NF set identifiers associated with the plurality of NF sets, wherein a NF set identifier is associated with a respective NF set; perform a count of available NF instances for each NF set based on the plurality of NF set identifiers; compare the count of available NF instances for each NF set to the minimum availability threshold; and determine whether the minimum availability threshold for a respective NF set is satisfied based on the comparison.

Example 3 is the computing apparatus of any previous or subsequent Example, wherein the processor-executable instructions, when executed by the one or more processors, further direct the computing apparatus to: determine that the minimum availability threshold for a subset of NF sets of the plurality of NF sets is not satisfied; identify a second subset of NF profiles from the registered NF profiles associated with the subset of NF sets comprising an unsatisfied minimum availability threshold; and removing the second subset of NF profiles from the listing of discoverable NF profiles based on the unsatisfied minimum availability threshold.

Example 4 is the computing apparatus of any previous or subsequent Example, wherein the processor-executable instructions to generate the listing of discoverable NF profiles from the subset of NF profiles based on the satisfied minimum availability threshold, when executed by the one or more processors, further direct the computing apparatus to: determine that the subset of NF profiles comprising satisfied minimum availability thresholds comprises a count of zero NF profiles; and generate the listing of discoverable NF profiles comprising the plurality of NF profiles.

Example 5 is the computing apparatus of any previous or subsequent Example, wherein the processor-executable instructions, when executed by the one or more processors, further direct the computing apparatus to: receive, from a consumer NF, a discovery request comprising a plurality of discovery parameters; filter the listing of discoverable NF profiles based on the plurality of discovery parameters; generate a discovery response comprising a subset of discoverable NF profiles from the listing of discoverable NF profiles; and transmit, to the consumer NF, the discovery response.

Example 6 is the computing apparatus of any previous or subsequent Example, wherein the processor-executable instructions, when executed by the one or more processors, further direct the computing apparatus to: receive, from a consumer NF, a discovery request comprising a plurality of discovery parameters; query the listing of discoverable NF profiles to determine whether any of the discoverable NF profiles satisfy the discovery parameters; determine that the listing of discoverable NF profiles comprises a count of zero NF profiles; filter the plurality of registered NF profiles based on the discovery parameters; generate a discovery response comprising a subset of registered NF profiles from the plurality of registered NF profiles, wherein the subset of registered NF profiles satisfies the discovery parameters; and transmit, to the consumer NF, the discovery response.

Example 7 is a method comprising: registering, by a first network function (NF) availability engine executing on a first NF instance, a first minimum availability threshold for a first NF set associated with the first NF instance, wherein the first minimum availability threshold defines a minimum number of NF instances required to maintain a fault tolerance level of the first NF set; registering, by a second NF availability engine executing on a second NF instance, a second minimum availability threshold for a second NF set associated with the second NF instance, wherein the second minimum availability threshold defines a minimum number of NF instances required to maintain a fault tolerance level of the second NF set; receiving, by a network repository function (NRF), a discovery request comprising a plurality of discovery parameters associated with a first session from a consumer NF; determining, by a third NF availability engine executing on the NRF, that the first minimum availability threshold for the first NF set is satisfied; generating, by the third NF availability engine, a listing of discoverable NF profiles, wherein the listing of discoverable NF profiles comprises a first NF profile associated with the first NF instance based on the first minimum availability threshold being satisfied; and transmitting, by the NRF, a discovery response comprising the listing of discoverable NF profiles.

Example 8 is the method of any previous or subsequent Example, wherein determining, by the third NF availability engine, that the first minimum availability threshold for the first NF set is satisfied comprises: determining, by the third NF availability engine, an NF set identifier associated with the first NF set; performing, by the third NF availability engine, a count of available instances for the first NF set based on the NF set identifier; comparing, by the third NF availability engine, the count of available instances to the first minimum availability threshold; and determining, by the third NF availability engine, that the first minimum availability threshold for the first NF set is satisfied based on the comparison.

Example 9 is the method of any previous or subsequent Example, wherein the method further comprises: responsive to receiving the discovery response, selecting, by the consumer NF, the first NF instance for service routing based on the first NF profile and the discovery parameters.

Example 10 is the method of any previous or subsequent Example, wherein the method further comprises: performing, by the third NF availability engine, a count of available NF instances for the second NF set; determining, by the third NF availability engine, that the second minimum availability threshold is not satisfied; and refraining, by the third NF availability engine, from including a second NF profile associated with the second NF instance in the listing of discoverable NF profiles.

Example 11 is the method of any previous or subsequent Example, wherein: generating, by the third NF availability engine, the listing of discoverable NF profiles is performed at a first time; and the method further comprises: receiving, by the NRF, a second discovery request comprising a second plurality of discovery parameters associated with a session from a second consumer; determining, by the third NF availability engine, that a count of discoverable NF profiles comprising satisfied minimum availability thresholds is zero at a second time, wherein the second time is subsequent to the first time; and generating, by the third NF availability engine, a second discovery response comprising registered NF profiles satisfying the second plurality of discovery parameters.

Example 12 is the method of any previous or subsequent Example, wherein the listing of discoverable NF profiles comprises a second NF profile associated with the second NF instance at a first time, and the method further comprises: performing, by the third NF availability engine, a count of available NF instances for the second NF set at a second time, wherein the second time is after the first time; determining, by the third NF availability engine, that the second minimum availability threshold for the second NF set is not satisfied based on the count of available NF instances of the second NF set at the second time; and removing, by the third NF availability engine, the second NF profile corresponding to the second NF instance from the listing of discoverable NF profiles.

Example 13 is the method of any previous or subsequent Example, wherein the method further comprises receiving, by an NF consumer, the discovery response; selecting, by the NF consumer, the first NF instance from the discovery response; performing, by a fourth NF availability engine executing on a Service Communication Proxy (SCP), a validation of the first minimum availability threshold for the first NF set associated with the first NF instance responsive to selection of the first NF instance by the NF consumer; and performing, by the fourth NF availability engine, alternate routing of a session request on behalf of the NF consumer to the second NF instance based on the first minimum availability threshold of the first NF set being unsatisfied.

Example 14 is the method of any previous or subsequent Example, wherein the method further comprises: selecting, by the consumer NF, the first NF profile from the listing of discoverable NF profiles; determining, by a fourth NF availability engine executing on the consumer NF, that service routing to the first NF instance is unsuccessful; determining, by the fourth NF availability engine, an NF set identifier associated with the first NF set; determining, by the fourth NF availability engine, the first minimum availability threshold for the first NF set based on the NF set identifier; determining, by the fourth NF availability engine, that the first minimum availability threshold of the first NF set is satisfied based on a number of available instances within the first NF set; and selecting, by the fourth NF availability engine, an alternative NF profile within the first NF set based on the first minimum availability threshold being satisfied.

Example 15 is a computer-readable storage medium comprising processor-executable instructions, wherein the processor-executable instructions, in part, operate a network function (NF) availability engine executing within one or more NFs within a network such to cause one or more processors to: determine, by the NF availability engine, a plurality of NF profiles for potential service routing, wherein the plurality of NF profiles correspond to a plurality of NF sets; determine, by the NF availability engine, a first minimum availability threshold for a first NF set within the plurality of NF sets; determine, by the NF availability engine, a number of available instances within the first NF set; compare, by the NF availability engine, the number of available instances within the first NF set to the first minimum availability threshold; determine, by the NF availability engine, that the first NF set comprises a satisfied minimum availability threshold based on the comparison; and identify, by the NF availability engine, a first NF profile associated with the first NF set for service routing, wherein the plurality of NF profiles comprises the first NF profile.

Example 16 is the computer-readable storage medium of any previous or subsequent Example, wherein: the processor-executable instructions to determine, by the NF availability engine, the plurality of NF profiles for potential service routing cause the one or more processors to further execute processor-executable instructions stored in the computer-readable storage medium to: receive, by the NF availability engine executing on a consumer NF, a discovery response from a network repository function (NRF), wherein the discovery response comprises the plurality of NF profiles; and the processor-executable instructions cause the one or more processors to further execute processor-executable instructions stored in the computer-readable storage medium to: select, by the NF availability engine, the first NF profile from the plurality of NF profiles for service routing; determine, by the NF availability engine, that service routing to a first NF instance associated with the first NF profile is unsuccessful, wherein the first NF set comprises the first NF instance; confirm, by the NF availability engine, that the first minimum availability threshold of the first NF set is satisfied; and select, by the NF availability engine, a second NF instance in the first NF set from the plurality of NF profiles for service routing based on the minimum availability threshold being satisfied.

Example 17 is the computer-readable storage medium of any previous or subsequent Example, wherein: the processor-executable instructions to determine, by the NF availability engine, the plurality of NF profiles for potential service routing cause the one or more processors to further execute processor-executable instructions stored in the computer-readable storage medium to: receive, by the NF availability engine executing on a consumer NF, a discovery response from a network repository function (NRF), wherein the discovery response comprises the plurality of NF profiles; and the processor-executable instructions cause the one or more processors to further execute processor-executable instructions stored in the computer-readable storage medium to: select, by the NF availability engine, the first NF profile from the plurality of NF profiles; determine, by the NF availability engine, that service routing to a first NF instance associated with the first NF profile is unsuccessful, wherein the first NF set comprises the first NF instance; determine, by the NF availability engine, that the first minimum availability threshold of the first NF set is no longer satisfied; and select, by the NF availability engine, a second NF profile from the plurality of NF profiles for service routing based on the minimum availability threshold not being satisfied for the first NF set, wherein the second NF profile corresponds to a second NF set.

Example 18 is the computer-readable storage medium of any previous or subsequent Example, wherein the processor-executable instructions to determine, by the NF availability engine, the first minimum availability threshold for the first NF set within the plurality of NF sets cause the one or more processors to further execute processor-executable instructions stored in the computer-readable storage medium to: parse, by the NF availability engine, vendor specific data within the first NF profile to determine the first minimum availability threshold for the first NF set.

Example 19 is the computer-readable storage medium of any previous or subsequent Example, wherein the processor-executable instructions to determine, by the NF availability engine, the first minimum availability threshold for the first NF set within the plurality of NF sets cause the one or more processors to further execute processor-executable instructions stored in the computer-readable storage medium to: determine, by the NF availability engine, a first NF set identifier associated with the first NF set; query, by the NF availability engine, an operator configuration table stored by a network repository function (NRF) using the first NF set identifier as a key; and determine, by the NF availability engine, the first minimum availability threshold for the first NF set from the operator configuration table.

Example 20 is the computer-readable storage medium of any previous or subsequent Example, wherein: the NF availability engine determines the number of available instances within the first NF set at a first time; the processor-executable instructions cause the one or more processors to further execute processor-executable instructions stored in the computer-readable storage medium to: determine, by the NF availability engine, a number of available instances within the first NF at a second time, wherein the second time is subsequent to the first time; determine, by the NF availability engine, a number of NF profiles comprising a satisfied minimum availability threshold is zero based on the number of available instances within the first NF set at the second time and the first minimum availability threshold for the first NF set; and determine, by the NF availability engine, discovery parameters associated with the service routing; and the processor-executable instructions to identify, by the NF availability engine, the first NF profile associated with the first NF set for service routing cause the one or more processors to further execute processor-executable instructions stored in the computer-readable storage medium to: filter, by the NF availability engine, the plurality of NF profiles based on the discovery parameters; and determine, by the NF availability engine, that the first NF profile satisfies the discovery parameters.

Example 21 is the computer-readable storage medium of any previous or subsequent Example, wherein the processor-executable instructions determine the first minimum availability threshold for the first NF set within the plurality of NF sets cause the one or more processors to further execute processor-executable instructions stored in the computer-readable storage medium to: receive, from an NF consumer, a selection of an initial NF instance for a new session request; determine, by the NF availability engine, that a minimum availability threshold for an initial NF set associated with the initial NF instance is unsatisfied responsive to selection of the initial NF instance by the NF consumer; and perform, by the NF availability engine, alternate routing of the new session request on behalf of the NF consumer, wherein performing the alternate routing comprises determining the first minimum availability threshold for the first NF set within the plurality of NF sets

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate a network repository function (NRF) within a network, wherein the NRF comprises a network function (NF) availability engine, such that the processor-executable instructions, when executed by the one or more processors, direct the computing apparatus, to at least:
determine a plurality of registered NF profiles;
identify a plurality of NF sets, wherein each NF set comprises one or more NF instances, with each NF instance being associated with one or more registered NF profiles of the plurality of registered NF profiles;
determine a minimum availability threshold for each NF set in the plurality of NF sets, wherein the minimum availability threshold defines a minimum number of NF instances required to maintain a fault tolerance level of the respective NF set;
determine whether the minimum availability threshold in a respective NF set is satisfied;
identify a subset of NF profiles from the registered NF profiles that correspond to a respective NF set comprising a satisfied minimum availability threshold; and
generate a listing of discoverable NF profiles from the subset of NF profiles based on the satisfied minimum available threshold.

2. The computing apparatus of claim 1, wherein the processor-executable instructions to determine whether the minimum availability threshold in a respective NF set is satisfied, when executed by the one or more processors, further direct the computing apparatus to:
determine a plurality of NF set identifiers associated with the plurality of NF sets, wherein a NF set identifier is associated with a respective NF set;
perform a count of available NF instances for each NF set based on the plurality of NF set identifiers;
compare the count of available NF instances for each NF set to the minimum availability threshold; and
determine whether the minimum availability threshold for a respective NF set is satisfied based on the comparison.

3. The computing apparatus of claim 1, wherein the processor-executable instructions, when executed by the one or more processors, further direct the computing apparatus to:
determine that the minimum availability threshold for a subset of NF sets of the plurality of NF sets is not satisfied;
identify a second subset of NF profiles from the registered NF profiles associated with the subset of NF sets comprising an unsatisfied minimum availability threshold; and
removing the second subset of NF profiles from the listing of discoverable NF profiles based on the unsatisfied minimum availability threshold.

4. The computing apparatus of claim 1, wherein the processor-executable instructions to generate the listing of discoverable NF profiles from the subset of NF profiles based on the satisfied minimum availability threshold, when executed by the one or more processors, further direct the computing apparatus to:
determine that the subset of NF profiles comprising satisfied minimum availability thresholds comprises a count of zero NF profiles; and
generate the listing of discoverable NF profiles comprising the plurality of NF profiles.

5. The computing apparatus of claim 1, wherein the processor-executable instructions, when executed by the one or more processors, further direct the computing apparatus to:
receive, from a consumer NF, a discovery request comprising a plurality of discovery parameters;
filter the listing of discoverable NF profiles based on the plurality of discovery parameters;
generate a discovery response comprising a subset of discoverable NF profiles from the listing of discoverable NF profiles; and
transmit, to the consumer NF, the discovery response.

6. The computing apparatus of claim 1, wherein the processor-executable instructions, when executed by the one or more processors, further direct the computing apparatus to:
receive, from a consumer NF, a discovery request comprising a plurality of discovery parameters;
query the listing of discoverable NF profiles to determine whether any of the discoverable NF profiles satisfy the discovery parameters;
determine that the listing of discoverable NF profiles comprises a count of zero NF profiles;
filter the plurality of registered NF profiles based on the discovery parameters;
generate a discovery response comprising a subset of registered NF profiles from the plurality of registered NF profiles, wherein the subset of registered NF profiles satisfies the discovery parameters; and
transmit, to the consumer NF, the discovery response.

7. A method comprising:
registering, by a first network function (NF) availability engine executing on a first NF instance, a first minimum availability threshold for a first NF set associated with the first NF instance, wherein the first minimum availability threshold defines a minimum number of NF instances required to maintain a fault tolerance level of the first NF set;
registering, by a second NF availability engine executing on a second NF instance, a second minimum availability threshold for a second NF set associated with the second NF instance, wherein the second minimum availability threshold defines a minimum number of NF instances required to maintain a fault tolerance level of the second NF set;
receiving, by a network repository function (NRF), a discovery request comprising a plurality of discovery parameters associated with a first session from a consumer NF;
determining, by a third NF availability engine executing on the NRF, that the first minimum availability threshold for the first NF set is satisfied;
generating, by the third NF availability engine, a listing of discoverable NF profiles, wherein the listing of discoverable NF profiles comprises a first NF profile associated with the first NF instance based on the first minimum availability threshold being satisfied; and
transmitting, by the NRF, a discovery response comprising the listing of discoverable NF profiles.

8. The method of claim 7, wherein determining, by the third NF availability engine, that the first minimum availability threshold for the first NF set is satisfied comprises:
determining, by the third NF availability engine, an NF set identifier associated with the first NF set;
performing, by the third NF availability engine, a count of available instances for the first NF set based on the NF set identifier;
comparing, by the third NF availability engine, the count of available instances to the first minimum availability threshold; and
determining, by the third NF availability engine, that the first minimum availability threshold for the first NF set is satisfied based on the comparison.

9. The method of claim 7, wherein the method further comprises:
responsive to receiving the discovery response, selecting, by the consumer NF, the first NF instance for service routing based on the first NF profile and the discovery parameters.

10. The method of claim 7, wherein the method further comprises:
performing, by the third NF availability engine, a count of available NF instances for the second NF set;
determining, by the third NF availability engine, that the second minimum availability threshold is not satisfied; and
refraining, by the third NF availability engine, from including a second NF profile associated with the second NF instance in the listing of discoverable NF profiles.

11. The method of claim 7, wherein:
generating, by the third NF availability engine, the listing of discoverable NF profiles is performed at a first time; and
the method further comprises:
receiving, by the NRF, a second discovery request comprising a second plurality of discovery parameters associated with a session from a second consumer;
determining, by the third NF availability engine, that a count of discoverable NF profiles comprising satisfied minimum availability thresholds is zero at a second time, wherein the second time is subsequent to the first time; and
generating, by the third NF availability engine, a second discovery response comprising registered NF profiles satisfying the second plurality of discovery parameters.

12. The method of claim 7, wherein the listing of discoverable NF profiles comprises a second NF profile associated with the second NF instance at a first time, and the method further comprises:
performing, by the third NF availability engine, a count of available NF instances for the second NF set at a second time, wherein the second time is after the first time;
determining, by the third NF availability engine, that the second minimum availability threshold for the second NF set is not satisfied based on the count of available NF instances of the second NF set at the second time; and
removing, by the third NF availability engine, the second NF profile corresponding to the second NF instance from the listing of discoverable NF profiles.

13. The method of claim 7, wherein the method further comprises:
receiving, by an NF consumer, the discovery response;
selecting, by the NF consumer, the first NF instance from the discovery response;
performing, by a fourth NF availability engine executing on a Service Communication Proxy (SCP), a validation of the first minimum availability threshold for the first NF set associated with the first NF instance responsive to selection of the first NF instance by the NF consumer; and
performing, by the fourth NF availability engine, alternate routing of a session request on behalf of the NF consumer to the second NF instance based on the first minimum availability threshold of the first NF set being unsatisfied.

14. The method of claim 7, wherein the method further comprises:
selecting, by the consumer NF, the first NF profile from the listing of discoverable NF profiles;
determining, by a fourth NF availability engine executing on the consumer NF, that service routing to the first NF instance is unsuccessful;
determining, by the fourth NF availability engine, an NF set identifier associated with the first NF set;
determining, by the fourth NF availability engine, the first minimum availability threshold for the first NF set based on the NF set identifier;
determining, by the fourth NF availability engine, that the first minimum availability threshold of the first NF set is satisfied based on a number of available instances within the first NF set; and
selecting, by the fourth NF availability engine, an alternative NF profile within the first NF set based on the first minimum availability threshold being satisfied.

15. A computer-readable storage medium comprising processor-executable instructions, wherein the processor-executable instructions, in part, operate a network function (NF) availability engine executing within one or more NFs within a network such to cause one or more processors to:
determine, by the NF availability engine, a plurality of NF profiles for potential service routing, wherein the plurality of NF profiles correspond to a plurality of NF sets;
determine, by the NF availability engine, a first minimum availability threshold for a first NF set within the plurality of NF sets;
determine, by the NF availability engine, a number of available instances within the first NF set;
compare, by the NF availability engine, the number of available instances within the first NF set to the first minimum availability threshold;
determine, by the NF availability engine, that the first NF set comprises a satisfied minimum availability threshold based on the comparison; and
identify, by the NF availability engine, a first NF profile associated with the first NF set for service routing, wherein the plurality of NF profiles comprises the first NF profile.

16. The computer-readable storage medium of claim 15, wherein:
the processor-executable instructions to determine, by the NF availability engine, the plurality of NF profiles for potential service routing cause the one or more processors to further execute processor-executable instructions stored in the computer-readable storage medium to:
receive, by the NF availability engine executing on a consumer NF, a discovery response from a network repository function (NRF), wherein the discovery response comprises the plurality of NF profiles; and
the processor-executable instructions cause the one or more processors to further execute processor-executable instructions stored in the computer-readable storage medium to:
select, by the NF availability engine, the first NF profile from the plurality of NF profiles for service routing;
determine, by the NF availability engine, that service routing to a first NF instance associated with the first NF profile is unsuccessful, wherein the first NF set comprises the first NF instance;
confirm, by the NF availability engine, that the first minimum availability threshold of the first NF set is satisfied; and
select, by the NF availability engine, a second NF instance in the first NF set from the plurality of NF profiles for service routing based on the minimum availability threshold being satisfied.

17. The computer-readable storage medium of claim 15, wherein:
the processor-executable instructions to determine, by the NF availability engine, the plurality of NF profiles for potential service routing cause the one or more processors to further execute processor-executable instructions stored in the computer-readable storage medium to:
receive, by the NF availability engine executing on a consumer NF, a discovery response from a network repository function (NRF), wherein the discovery response comprises the plurality of NF profiles; and
the processor-executable instructions cause the one or more processors to further execute processor-executable instructions stored in the computer-readable storage medium to:
select, by the NF availability engine, the first NF profile from the plurality of NF profiles;
determine, by the NF availability engine, that service routing to a first NF instance associated with the first NF profile is unsuccessful, wherein the first NF set comprises the first NF instance;
determine, by the NF availability engine, that the first minimum availability threshold of the first NF set is no longer satisfied; and
select, by the NF availability engine, a second NF profile from the plurality of NF profiles for service routing based on the minimum availability threshold not being satisfied for the first NF set, wherein the second NF profile corresponds to a second NF set.

18. The computer-readable storage medium of claim 15, wherein the processor-executable instructions to determine, by the NF availability engine, the first minimum availability threshold for the first NF set within the plurality of NF sets cause the one or more processors to further execute processor-executable instructions stored in the computer-readable storage medium to:
parse, by the NF availability engine, vendor specific data within the first NF profile to determine the first minimum availability threshold for the first NF set.

19. The computer-readable storage medium of claim 15, wherein the processor-executable instructions to determine, by the NF availability engine, the first minimum availability threshold for the first NF set within the plurality of NF sets cause the one or more processors to further execute processor-executable instructions stored in the computer-readable storage medium to:
determine, by the NF availability engine, a first NF set identifier associated with the first NF set;
query, by the NF availability engine, an operator configuration table stored by a network repository function (NRF) using the first NF set identifier as a key; and
determine, by the NF availability engine, the first minimum availability threshold for the first NF set from the operator configuration table.

20. The computer-readable storage medium of claim 15, wherein:
the NF availability engine determines the number of available instances within the first NF set at a first time;
the processor-executable instructions cause the one or more processors to further execute processor-executable instructions stored in the computer-readable storage medium to:
determine, by the NF availability engine, a number of available instances within the first NF at a second time, wherein the second time is subsequent to the first time;
determine, by the NF availability engine, a number of NF profiles comprising a satisfied minimum availability threshold is zero based on the number of available instances within the first NF set at the second time and the first minimum availability threshold for the first NF set; and
determine, by the NF availability engine, discovery parameters associated with the service routing; and
the processor-executable instructions to identify, by the NF availability engine, the first NF profile associated with the first NF set for service routing cause the one or more processors to further execute processor-executable instructions stored in the computer-readable storage medium to:
filter, by the NF availability engine, the plurality of NF profiles based on the discovery parameters; and
determine, by the NF availability engine, that the first NF profile satisfies the discovery parameters.

21. The computer-readable storage medium of claim 15, wherein the processor-executable instructions determine the first minimum availability threshold for the first NF set within the plurality of NF sets cause the one or more processors to further execute processor-executable instructions stored in the computer-readable storage medium to:
receive, from an NF consumer, a selection of an initial NF instance for a new session request;
determine, by the NF availability engine, that a minimum availability threshold for an initial NF set associated with the initial NF instance is unsatisfied responsive to selection of the initial NF instance by the NF consumer; and
perform, by the NF availability engine, alternate routing of the new session request on behalf of the NF consumer, wherein performing the alternate routing comprises determining the first minimum availability threshold for the first NF set within the plurality of NF sets.
